(19) United States
(12) Patent Application Publication
(10) Pub. No.: US 2019/0313841 A1
(43) Pub. Date: Oct. 17, 2019

(54) FLUID CONDUIT CLEANING APPARATUS AND METHOD

(71) Applicant: HYGIENIC INNOVATIONS LTD, Chester Cheshire (GB)

(72) Inventor: Jonathan Quinn, Headley Berkshire (GB)

(73) Assignee: HYGIENIC INNOVATIONS LTD, Chester Cheshire (GB)

(21) Appl. No.: 16/472,135

(22) PCT Filed: Dec. 20, 2017
(86) PCT No.: PCT/GB2017/053846

§ 371 Date: Jun. 20, 2019

(30) Foreign Application Priority Data
Dec. 20, 2016 (GB) 1621691.3

(51) Int. Cl. A47J 31/60; B08B 3/12

(52) U.S. Cl. CPC A47J 31/60; B08B 3/12

(57) ABSTRACT

An apparatus (100) for cleaning open ended conduits such as milk steam wands (10) comprises a container (106) connected to an ultrasonic transducer (132) to clean the conduit (10) immersed in liquid (12).

The present invention is concerned with an open ended fluid conduit cleaning apparatus and method. More specifically, the present invention is concerned with an ultrasonic cleaning device for removing fresh, dried and/or encrusted milk residue from a coffee machine steam wand.

Although the following disclosure will focus on steam wands, the device is also suitable for use with other open-ended dispensing tubes such as ice cream dispenser nozzles, beer dispenser nozzles, sauce dispensers and any food or drink dispensers where a product comes down a tube or nozzle and can lead to bacterial build up inside.

Coffee machines, as well as the fundamental coffee-making equipment often comprise steam nozzles, also known as steam “wands”. Such wands typically comprise a tube constructed from a metal material which extends from the machine in a generally downward direction terminating in a steam outlet. The wand is in fluid communication with a steam generator, and the user is able to operate a control on the machine to selectively pass high pressure steam through the wand to exit at the orifice. In use, a container (such as a jug) is partially filled with cold milk and positioned such that the steam orifice is below the surface of the milk. The user then turns on the steam flow such that steam from the wand warms and aerates and foams the milk. Warm, foamed milk is used to prepare several coffee drinks such as cappuccinos and lattes, as well as some non-coffee drinks such as hot chocolate.

Steam wands typically have an elongate downwardly depending portion terminating in the orifice. This is because it is advantageous to position the orifice near the base of the jug. This provides maximum contact between the ejected steam and the milk. When the foaming process is complete, the jug is removed to prepare the drink.

Once the jug is removed, milk residue is usually present on the previously submerged part of the wand. It is the responsibility of the user to wipe the wand with a damp cloth to remove the residue after each use. This avoids the residue drying and building up on the wand (accelerated by the fact that the wand is hot). Build-up of milk residue is unhygienic, and may also generate a bitter and burnt tasting drinks when the wand is re-used.

There are several problems with the prior art approach to steam wand cleaning.

Firstly, the removal of residue is dependent on the user's swift action (before the residue dries). A delay whilst the drink is prepared will allow the residue to solidify, which makes it very difficult to remove with a cloth. Therefore the “damp cloth” method relies on the user (i) remembering to wipe and (ii) wiping immediately after use- even before he or she has finished preparing the drink.

Secondly, the same cloth is used many times throughout the day. Given that it is periodically in contact with a hot or warm surface, and that it has milk reside present on it, it is a viable breeding ground for bacteria and other harmful microorganisms. This presents a hygiene risk. After touching the cloth, staff members then go onto touch a number of other items before again touching the cloth which can cause cross contamination. In particular money is known to contain a lot of surface bacteria, and in a coffee shop staff will handle money between making each drink. Presently, staff would need to wash their hands after each contact with money, which is impractical and time consuming.

Thirdly, the “damp cloth” method requires some care. If the user slips, or is not holding the cloth properly, he or she may contact the wand with their hand, which may cause burns. Wands are typically constructed from metal, and thus conduct heat from the steam quickly and effectively.

Fourthly, some wands are copper plated. Vigorous wiping (especially if a scouring pad is used) can cause wearing and corrosion of the plating. The presence of copper particles in milk is problematic from a health point of view.

Many other open-ended dispenser conduits suffer from these problems.

It is an aim of the present invention to overcome, or at least mitigate, the above problems.

According to a first aspect of the invention there is provided a hand-held cleaning apparatus for open ended conduits of food and drink preparation and production devices comprising:
a container for receiving a liquid, the container having an opening for a conduit;
an ultrasonic transducer configured to transmit ultrasonic energy into the container in use.

By “hand-held” we mean capable of being comfortably held by one or two human hands for several seconds. Specifically, the hand-held apparatus preferably weighs less than 1.5 kg (without water), more preferably less than 1.3 kg and most preferably less than 1.0 kg. Preferably the apparatus has a perimeter in a horizontal plane, defining a maximum cross-sectional area of 160 cm². In other words, it has a maximum diameter of 150 mm. More preferably, there is a portion of the device containing the container which has a maximum diameter of 100 mm. Most preferably, the diameter is 50-75 mm.

Preferably, the portion of the device comprising the container has a maximum height of 200 mm, more preferably less than 180 mm to allow insertion into coffee machines. Preferably, the maximum horizontal dimension of the portion of the device comprising the container is 200 mm, and more preferably 180 mm.

Advantageously, the provision of a hand-held ultrasonic cleaning devices overcomes many of the problems of the prior art. Firstly, the system is adept at removing dried-on residue. As such there is less need to clean the wand immediately after use. Cleaning can, for example, wait until the drink has been prepared. Secondly, the system is more hygienic, and the liquid can be regularly replaced. The apparatus also cleans inside the wand, which a cloth cannot do. Thirdly, there is greatly limited likelihood of contact between the user's hand and the wand. The invention overcomes the equivalent problems with other open-ended conduits and dispensers- particularly by cleaning inside the conduit.

Preferably the container comprises a base end opposite the opening, and the apparatus comprises a base, adjacent the base end of the container, the base housing the ultrasonic transducer. This provides a compact arrangement. Preferably the ultrasonic transducer is in contact with the base end of the container to facilitate the transmittal of ultrasonic energy.

Preferably the apparatus comprises a battery arranged to power the ultrasonic transducer. This allows the apparatus to be portable and not require the encumbrance of a power lead, which may be problematic in a busy coffee shop.

Preferably the apparatus has two main parts:
a container assembly comprising the container, the ultrasonic transducer and the battery; and,
a dock;
in which the dock is configured to charge the battery when the container assembly is assembled therewith.

This allows quick and easy charging of the battery.

Preferably the dock is configured to charge the battery by induction charging. This prevents any problems with liquids coming into contact with electrical contacts.

Preferably the container comprises a container outer and a container inner, in which the container outer is constructed from a first material, and the container inner is constructed from a second, different material. Preferably the container outer is constructed from a plastics material. Preferably the container inner is constructed from a metal material. The provision of a separate outer insulates the user's hand from both the temperature of the liquid (should it get hot) and also any vibration from the transducer. Plastic, in particular is good for this. Using metal on the inner is advantageous as it is very stiff, and therefore tends not to absorb or attenuate the ultrasonic energy as less stiff materials would.

Preferably the container comprises a handle to make the apparatus easy to handle. Preferably the apparatus is similar in size and shape to a mug.

Preferably the apparatus comprises a controller configured to control the ultrasonic transducer, in which the controller has a user-activated input. More preferably the controller has at least two modes of operation in which the time which the ultrasonic transducer is activated for is different for each mode. So, for example, a short burst may be used for regular cleaning, and a longer burst (e.g. 1 minute) for a “deep clean”.

Preferably the controller is configured to prompt the user to perform a “deep clean” after a predetermined number of cleaning cycles, or a predetermined amount of cleaning time.

According to a second aspect of the invention there is provided a method of cleaning an open ended food/drink conduit such as a milk steam wand comprising the steps of:
providing a food or drink making machine having open-ended conduit attached thereto;
providing an assembly of a container and an ultrasonic transducer;
at least partially filling the container with a liquid;
moving the container into position such that the conduit is at least partially immersed in the liquid whilst still being attached to the machine;
activating the ultrasonic transducer to transmit ultrasonic energy to the liquid to clean the conduit.

Preferably the ultrasonic transducer is activated for between 5 and 30s.

An example steam nozzle cleaning apparatus and method will now be described with reference to the drawings in which:

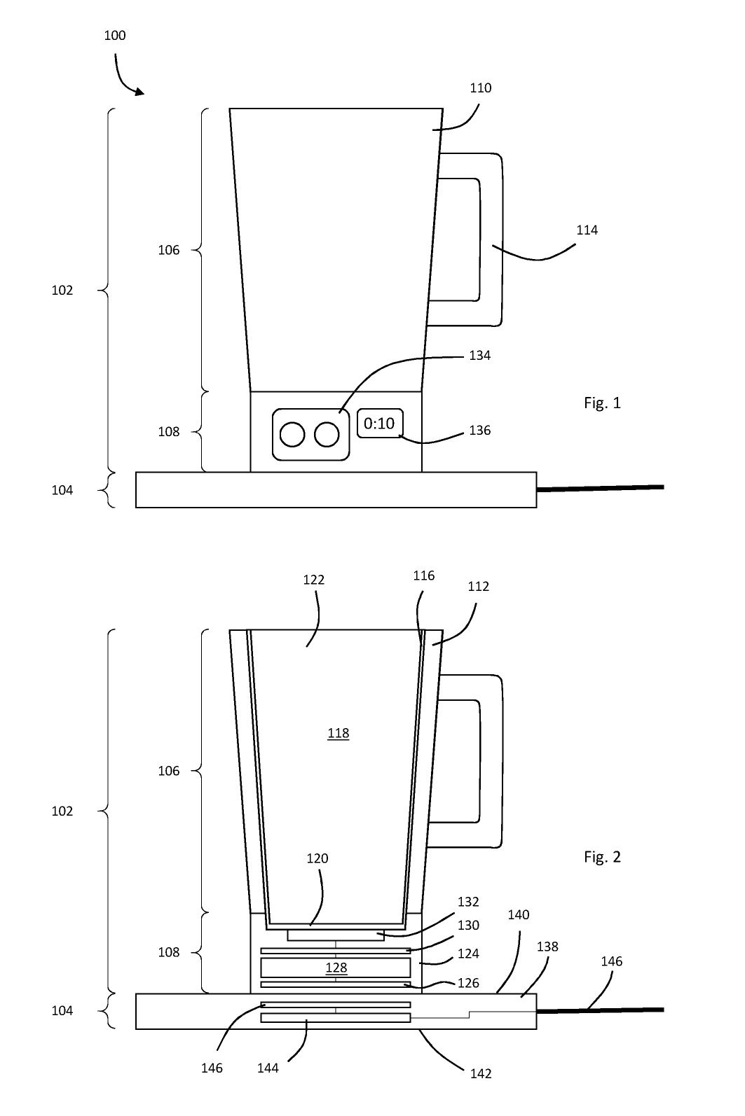

FIG. 1 is a side view of a first apparatus in accordance with the present invention;

FIG. 2 is a side schematic section view of the apparatus of FIG. 1;

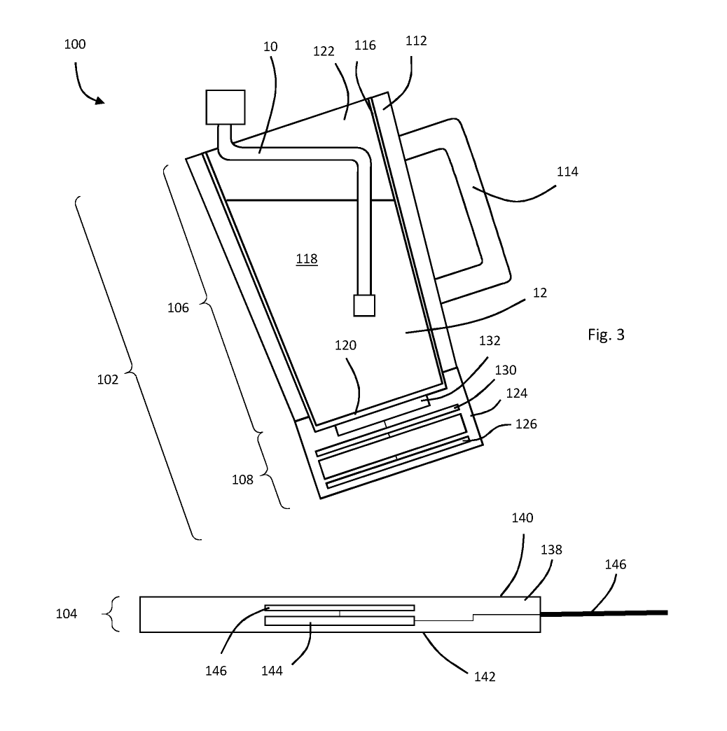

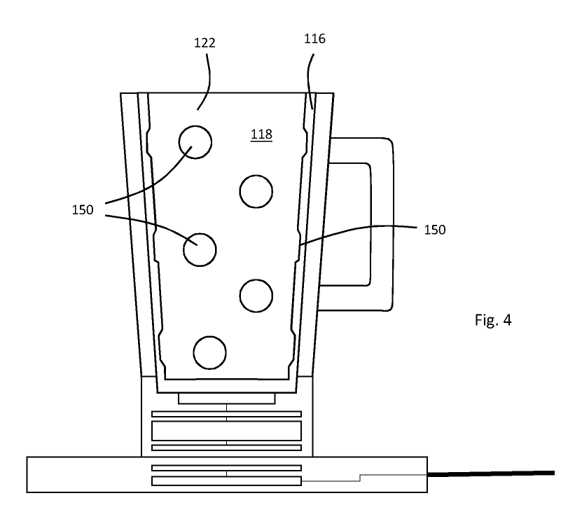

FIG. 3 is a side schematic section view of the apparatus of FIG. 1 in use; and,

FIG. 4 a side schematic section view of a second apparatus in accordance with the present invention.

A steam nozzle cleaning apparatus 100 comprises a hand-held assembly 102 and a dock 104.

The hand-held assembly 102 comprises a fluid container 106 and a base 108.

The fluid container 106 comprises a container outer 110 having a wall 112 defining a cavity. The wall 112 has a handle 114 projecting outwardly therefrom. The handle 114 is configured to be gripped by a human hand. The container outer 110 is constructed from a moulded plastic material. A container inner 116 is provided. The container inner 116 is generally cup-shaped defining a cavity 118 therein. The container inner has a closed base end 120 and an open end 122. The container inner 116 is constructed from stainless steel. The fluid container 116 is configured to be hand-held—that is, it is of a size, shape and weight to allow it to be held in use. By way of example, the container weighs 0.8 kg, and preferably it has a perimeter in a horizontal plane, excluding the handle, defining a maximum cross-sectional area of 160 cm².

The container inner 116 is attached to, and held within, the container outer 110.

The base 108 comprises a housing 124. Within the housing 124 there is provided an induction loop 126, a battery 128, a control circuit board 130 and an ultrasonic transducer 132. The base 108 further comprises a control panel 134 and a display 136 attached to an outer surface thereof.

The induction loop 126 is positioned proximate a first surface of the housing 124. It is connected to the battery 128, which in turn is connected to the control circuit board 130 to provide power thereto. The control circuit board 130 is configured to selectively activate the ultrasonic transducer 132 upon user input from the control panel 134. The control circuit board 130 is further configured to control the display 136.

The fluid container 108 is attached to the base 108 at a second surface of the housing 124 opposite the first surface. In use, the induction loop 126 is at the bottom of the base 108. The ultrasonic transducer 132 is in attached to, and therefore in physical contact with, the container inner 116 at the closed base end 120.

The dock 104 comprises a housing 138 having a first surface 140 and a second surface 142 opposite thereto. The housing 138 holds a transformer 142 and a dock induction coil 144. The dock induction coil 144 is positioned proximate the first surface 140 of the housing 138. The transformer 142 is connected to a mains electricity supply 146. The transformer 142 powers the dock induction coil 144.

The apparatus 100 has a docked condition in which the container 106 is positioned on the base 108 with the first surface of the housing 124 in contact with the first surface 140 of the housing 138 of the dock 104. This places the induction coils 126, 146 in electromagnetic range such that the battery 128 can be charged by energy from the mains electricity supply 146.

The apparatus 100 can be used to clean a steam wand 10 as shown in FIG. 3. The steam wand 10 is attached to a hot drink making machine such as a coffee machine. The hand-held assembly 102 is provided with water 12 in the cavity 118. The hand-held assembly 102 is then lifted from the base 104 by the handle 114 and moved into position to submerge at least part of the wand 10. It will be noted that the wand does not need to be removed from the machine. The user uses the control panel 134 to start the cleaning process. This causes the control circuit board 130 to supply power to the ultrasonic transducer 132. The transducer 132 generates ultrasonic vibrations which pass into the water 12 at a frequency (in this embodiment) of 40 kHz.

The transmission of ultrasonic energy acts to disrupt and disperse any solidified milk on the wand 10 into the water 12. It has been demonstrated that using power of 50 W at 40 kHz takes about 10 seconds to clear well-solidified milk residue.

The apparatus 100 is also configured to perform a deeper clean on the wand 10 for example, at the end of the day's use. In this instance, a separate control is used to start a longer burst of ultrasonic energy, e.g. 2 minutes. The water 12 may be replaced with a chemical cleaning fluid such as an anti-bacterial to provide enhanced cleaning.

In a further embodiment as shown in FIG. 4, the container inner 116 defines a series of concave depressions 150 on the interior surface thereof. The depressions 150 have been demonstrated to enhance the effect of the ultrasonic energy in cleaning the wand 10.

The hand-held assembly 102 needs to be compact enough to fit under a steam wand. For example, the maximum height of the assembly 102 is 200 mm, but more commonly less than 180 mm.

Variations fall within the scope of the present invention.

Instead of induction charging, it is envisaged that the apparatus 100 may be charged by complimentary electrical contacts on the hand-held assembly 102 and base 104. Alternatively, the hand-held assembly 102 may be powered by replaceable, disposable batteries. It may also be directly mains powered (although this requires a power lead be permanently attached). In a further example, it may be powered by removable batteries which are charged in a separate unit.

The container inner 116 may be constructed from, or coated with, a bacteria resistant material such as silver or titanium dioxide.

A smooth inner and an inner with depressions 150 have been described. It will be noted that the inner could have protrusions (convex) or a ribbed surface to influence the ultrasonic waves.

The controls may be positioned on the handle of the device for ease of use. For example, the controls could be positioned proximate the top of the handle to allow for operation by thumb.

The apparatus may be provided without a handle.

It will be appreciated by the skilled person that the invention can be adapted and used on other types of open-ended fluid conduits for food and drink preparation.

1. A hand-held cleaning apparatus for an open ended fluid conduit of a food and/or drink production device comprising:
a container for receiving a liquid, the container having an opening for a fluid conduit; and
an ultrasonic transducer configured to transmit ultrasonic energy into the container in use.

2. A hand-held cleaning apparatus according to claim 1, in which the container comprises a base end opposite the opening, and the apparatus comprises a base, adjacent the base end of the container, the base housing the ultrasonic transducer.

3. A hand-held cleaning apparatus according to claim 2, in which the ultrasonic transducer is in contact with the base end of the container.

4. A hand-held cleaning apparatus according to claim 1, comprising a battery arranged to power the ultrasonic transducer.

5. A hand-held cleaning apparatus according to claim 4, having:
a container assembly comprising the container, the ultrasonic transducer and the battery; and,
a dock;
in which the dock is configured to charge the battery when the container assembly is assembled therewith.

6. A hand-held cleaning apparatus according to claim 5, in which the dock is configured to charge the battery by induction charging.

7. A hand-held cleaning apparatus according to claim 1, in which the container comprises a container outer and a container inner, in which the container outer is constructed from a first material, and the container inner is constructed from a second, different material.

8. A hand-held cleaning apparatus according to claim 7, in which the container outer is constructed from a plastics material.

9. A hand-held cleaning apparatus according to claim 8 in which the container inner is constructed from a metal material.

10. A hand-held cleaning apparatus according to claim 1, in which the container comprises a handle.

11. A hand-held cleaning apparatus according to claim 1, comprising a controller configured to control the ultrasonic transducer, in which the controller has a user-activated input.

12. A hand-held cleaning apparatus according to claim 11, in which the controller has at least two modes of operation in which the time which the ultrasonic transducer is activated for is different for each mode.

13. A method of cleaning an open ended fluid conduit of a food and/or drink production device comprising the steps of:
providing a food and/or drink production device having an open ended fluid conduit attached thereto;
providing an assembly of a container and an ultrasonic transducer;
at least partially filling the container with a liquid;
moving the container into position such that the fluid conduit is at least partially immersed in the liquid whilst still being attached to the food and/or drink production device; and
activating the ultrasonic transducer to transmit ultrasonic energy to the liquid to clean the fluid conduit.

14. A method according to claim 13, in which the ultrasonic transducer is activated for between 5 seconds and 30 seconds.

15. (canceled)

16. (canceled)

17. (canceled)

18. (canceled)
